(19) United States
(12) Patent Application Publication
(10) Pub. No.: US 2007/0025810 A1
(43) Pub. Date: Feb. 1, 2007

(54) Folding mechanism

(75) Inventor: Feng Teng Huang, Taichung (TW)

Correspondence Address: HUANG, FENG TENG, 3620 168th St. apt 3D, Flushing, NY, 11358, US

(73) Assignee: HSIN YI FENG INDUSTRY CO., LTD

(21) Appl. No.: 11/178,137

(22) Filed: Jul. 11, 2005

(51) Int. Cl. F16C 11/06

(52) U.S. Cl. 403/161; 403/326

(57) ABSTRACT

A folding mechanism includes a first folding member having a first beveled joint face provided with a locating hole, and first and second lugs symmetrically provided below the first beveled joint face; and a second folding member having a second beveled joint face internally provided with a receiving space for receiving a locating element and a spring therein. A third lug is provided below the second joint face, so that a shaft may be extended through shaft holes on the first, second, and third lugs. When the first and second folding members are assembled with a right angle contained between them, the locating element is upward projected from the locating hole to hold the two folding members in place; and when the locating element is pushed out of the locating hole, the first folding member can be pivotally turned about the shaft to parallel the second folding member.

### FIELD OF THE INVENTION

The present invention relates to a folding mechanism, and more particularly to a folding mechanism including a first and a second folding member that can be easily set to an extended position with a right angle contained between them or a folded position to parallel with each other.

### BACKGROUND OF THE INVENTION

Many articles used in our daily life have a big volume. These big-size articles usually have a collapsible or folding structure and therefore include a plurality of joints or knuckles pivotally turnable about a pivot shaft each. L-shaped angles and some hand tools are needed to lock these joints or knuckles in place. It is obviously troublesome to do so. Therefore, it is desirable to develop a quickly and easily operable folding mechanism mounted to each joint or knuckle of the collapsible or folding big-size article to enable quick and easy setting of the article to a folded and extended position.

### SUMMARY OF THE INVENTION

A primary object of the present invention is to provide a folding mechanism including two folding members that can be easily set to an extended position with a right angle contained between them without the risk of loosening or separating from each other, or a folded position to parallel with each other.

To achieve the above and other objects, the folding mechanism according to the present invention includes a first folding member having a first beveled joint face provided with a locating hole, and first and second lugs symmetrically provided below the first beveled joint face; and a second folding member having a second beveled joint face internally provided with a receiving space for receiving a locating element and a spring therein. A third lug is provided below the second joint face, so that a shaft may be extended through shaft holes on the first, second, and third lugs. When the first and second folding members are assembled with a right angle contained between them, the locating element is upward projected from the locating hole to hold the two folding members in place; and when the locating element is pushed out of the locating hole, the first folding member can be pivotally turned about the shaft to parallel the second folding member.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a folding mechanism according to the present invention;

FIG. 2 is an assembled and partially cutaway perspective view of the folding mechanism of FIG. 1;

FIG. 3 is a sectional view showing the folding mechanism of the present invention in an extended position for use; and

FIG. 4 is a sectional view showing the folding mechanism of the present invention in a folded position.

### DETAILED DESCRIPTION OF THE PREFERRED EMBODIMENTS

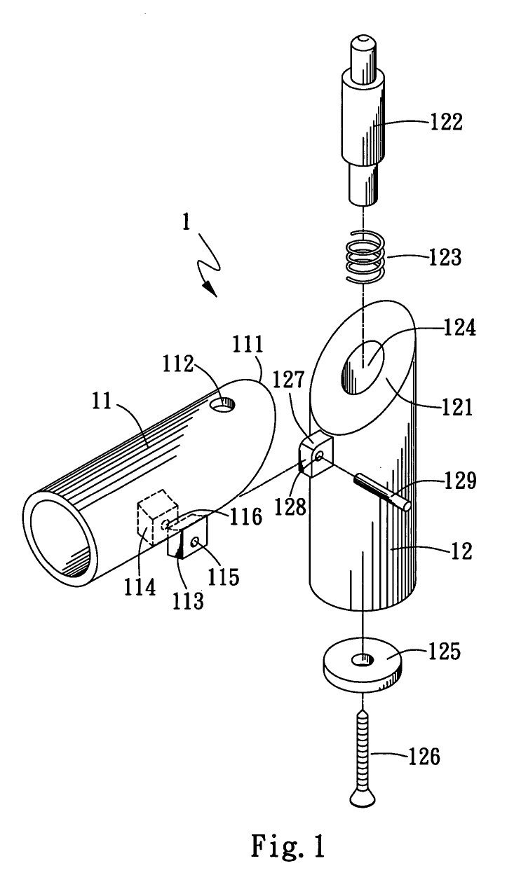

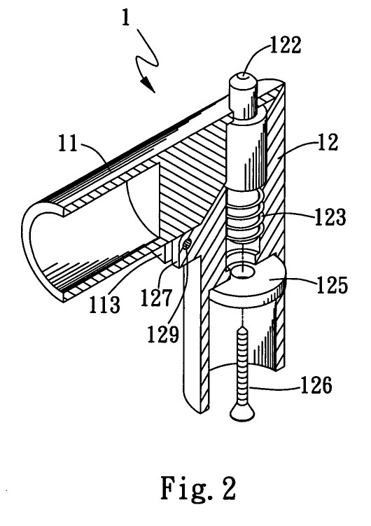

Please refer to FIGS. 1 and 2 that are exploded and assembled perspective views, respectively, of a folding mechanism 1 according to the present invention. FIG. 2 is partially cutaway to show an internal structure of the present invention. As shown, the folding mechanism 1 of the present invention includes a first and a second folding member 11, 12.

The first folding member 11 is provided at an end with a first beveled joint face 111. A radially extended locating hole 112 is formed on the first folding member 11 to communicate with the joint face 111, and two lugs, namely, a first and a second lug 113, 114, are symmetrically provided on the first folding member 11 closely below the joint face 111. The first and second lugs 113, 114 are respectively provided with a shaft hole 115, 116.

The second folding member 12 is provided at an end with a second beveled joint face 121. A receiving space 124 is formed on the second folding member 12 at the end with the beveled joint face 121 for a locating element 122 having an expanded middle portion and a spring 123 to mount therein. A through hole is formed at a bottom of the receiving space 124. A bottom seat 125 having a diameter larger than an inner diameter of the receiving space 124 is located below the through hole at the bottom of the receiving space 124 and connected to a bottom of the locating element 122 using a fastening element 126, such as a cap screw. A third lug 127 having a shaft hole 127 is provided on the second folding member 12 below the second beveled joint face 121 for fitly inserting into a space between the first and the second lug 113, 114, such that a shaft 129 may be extended through the shaft holes 115, 116, 128 of the first, the second, and the third lug 113, 114, 127. The first and the second folding member 11, 12 may be columns having a round, a rectangular, or a triangular cross section.

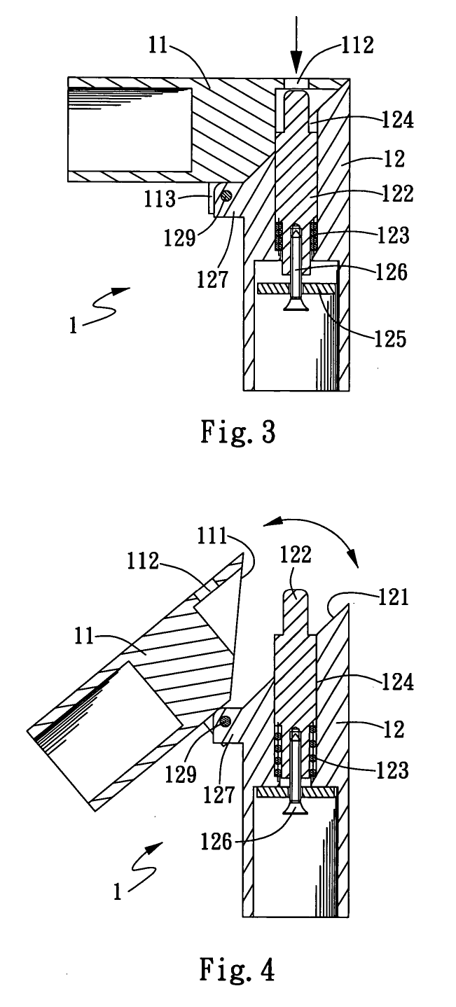

When the assembled first and second folding members 11, 12 are in a fully extended position with a right angle contained between them, as shown in FIG. 2, the locating element 122 in the second folding member 12 is projected from the locating hole 112 on the first folding member 11 to connect and hold the first and the second folding member 11, 12 to the right-angled position without the risk of loosening or separating from each other. Please refer to FIGS. 3 and 4. When it is desired to set the first and the second folding member 11, 12 to a folded position, simply depress the locating element 122 projected from the locating hole 112 on the first folding member 11 to move the locating element 122 out of the locating hole 112, and simultaneously downward press the first folding member 11 toward the second folding member 12. At this point, the first and the second joint face 111, 121 are separated from each other, and the first folding member 11 is pivotally turned about the shaft 129 extended through the first, the second, and the third lug 113, 114, 127 to move into a fully folded position to parallel the second folding member 12.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A folding mechanism, comprising a first and a second folding member;
said first folding member being provided at an end with a first beveled joint face, on a predetermined point with a radially extended locating hole to communicate with said first beveled joint face, and closely below said beveled joint face with a first and a second lug that are symmetrically arranged; and said first and second lugs being respectively provided with a shaft hole;
said second folding member being provided at an end with a second beveled joint face; a receiving space being formed in said second folding member at the end with said second beveled joint face for a locating element having an expanded middle portion and a spring to mount therein; a through hole being formed at a bottom of said receiving space for a fastening element to extend therethrough into a bottom of said locating element; and, a third lug having a shaft hole being provided on said second folding member below said second beveled joint face for fitly inserting into a space between said first and said second lug, such that a shaft may be extended through said shaft holes on said first, said second, and said third lug.

2. The folding mechanism as claimed in claim 1, wherein said first and said second folding member have across section selected from the group consisting of round, rectangular, and triangular shapes.

3. The folding mechanism as claimed in claim 1, wherein said through hole at the bottom of said receiving space has a bottom seat disposed therebelow, said bottom seat having a diameter larger than an inner diameter of said receiving space in said second beveled joint face, and being connected to the bottom of said locating element using said fastening element.

4. The folding mechanism as claimed in claim 1, wherein said locating element has an expanded middle portion.

5. The folding mechanism as claimed in claim 1, wherein said fastening element is a cap screw.
